(19) United States
(12) Patent Application Publication
(10) Pub. No.: US 2008/0026763 A1
(43) Pub. Date: Jan. 31, 2008

(54) System and method for providing SOHO BTS coverage based on angle of arrival of mobile station signals

(75) Inventors: Cornelius van Rensburg, Dallas, TX (US); Joseph Cleveland, Murphy, TX (US); Nivi Thadasina, Allen, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/492,737

(22) Filed: Jul. 25, 2006

(51) Int. Cl. H04Q 7/20

(52) U.S. Cl. 455/446

(57) ABSTRACT

Beamforming techniques to limit radiated power where there is the potential for interference with macro-cellular coverage or with adjacent mobile stations. Smart antenna beamforming techniques (including the use of angle of arrival information) are combined with access probe information to determine the direction for radiated power and the level of the needed transmitted power as well for the small office or home (SOHO) environment. The placement of RF power in the SOHO specific to where it is needed, minimizes radiating power in directions where it will cause interference with macrocell coverage. In addition, the beamforming techniques provide a base transceiver station with an economical method to quickly solve coverage issues internal to a SOHO, without introducing interference external to this coverage environment. In addition, there specific placement of the RF power where it is needed provides an increase in spectral efficiency of a deployed network.

### TECHNICAL FIELD OF THE DISCLOSURE

The present disclosure is directed, in general, to wireless communication systems and, more specifically, to the providing coverage to small office or home office wireless communication devices.

### BACKGROUND OF THE DISCLOSURE

Inadequate coverage is a persistent problem in the quality of service of any wireless network. Natural and man-made obstacles frequently create radio frequency (RF) holes in the coverage area of a wireless network. Voice and data call connections are frequently dropped when a wireless terminal, such as a cell phone or a similar mobile station, enters an RF hole. Mobile stations that are already in an RF hole may not be able to reliably establish new connections. Typical areas in which RF holes occur include homes, apartments, underground tunnels and office buildings.

Furthermore, wireless communication networks complimented by small base transceiver stations located to provide coverage in RF holes can frequently encounter coverage issues (e.g., interference from neighboring devices) that cause RF coverage holes. Even when such devices are configured to detect each other and adapt overall or directionally transmit power accordingly, interference may remain a problem.

For instance, a pair of small office or home office (SOHO) base transceiver stations in adjacent buildings may not detect each other due to outside wall penetration losses. A mobile or subscriber unit between or inside one of the two buildings, however, may detect both base transceiver stations even after taking into account factors such as distance, differences in interior versus exterior wall penetration losses, or both. Thus, the signal from the first SOHO base transceiver station (BTS) interferes with the signal from the second SOHO base transceiver station (BTS), or vice versa. Similarly, a signal from the first SOHO BTS may interfere with mobile stations located near the first SOHO BTS. This interference scenario is sometimes referred to as the “hidden node” problem. Conventional adaptive interference controls for a SOHO BTS may provide power control into a single antenna. For example, some adaptive interface controls currently use solitary dipole or monopole antennas. Such controls fail to provide selective reduction of transmitted RF power that could ultimately cause interference.

A SOHO BTS is typically placed within the confines of a SOHO and generally provides sufficient transmit power to overcome the attenuation of interior walls and floors. Often times, a SOHO BTS supplements a network where coverage is poor. Ideally, a SOHO BTS should operate without introducing significant interference to the external coverage environment. However, in practice, a SOHO BTS is often subjected to high interference.

In a code division multiple access (CDMA) environment, many systems known in the art report the number of pilots in an active set to a base station by a Power Measurement Report Message (PMRM), Pilot Strength Measurement Message (PSMM), Registration Message (RM) or similar. Currently, however, there is no system for analyzing pilot strength measurements to aid in tailoring the transmit power pattern by learning the angle of arrival with beamforming techniques to provide coverage in a small office or home office while minimizing interference external to the small office or home office.

There is therefore a need for a system to manage power adjustments of a SOHO BTS and to minimize the impact of interference with any neighboring SOHO BTSs while maintaining adequate interior coverage. Moreover, there is a need for a system to determine the interior coverage by discovery of the angle-of-arrival of any signals from mobile stations within the SOHO.

### SUMMARY OF THE DISCLOSURE

The present disclosure provides a small office and home office (SOHO) base transceiver station (BTS) Management Server that optimizes RF coverage while limiting interference to neighboring mobile stations by correlating angle of arrival information from signal originating from such mobile stations.

In one embodiment of the present disclosure, a system for managing interference with a base transceiver station having one or more transmit paths is disclosed. The system includes an antenna array coupled to one of the transmit paths. The system also includes a controller to direct a setting for the antenna array of the base transceiver station based on an angle of arrival of a signal from a mobile station.

In another embodiment of the present disclosure, a method for managing interference from a base transceiver stations having one or more transmit paths is disclosed. The method includes directing an antenna array coupled to at least one of the transmit paths of the base transceiver station based on an angle of arrival of a signal from a mobile station.

In still another embodiment of the present disclosure, a method for managing interference from a base transceiver station having one or more transmit paths is disclosed. The method includes configuring an antenna array at the base transceiver station for uniform coverage. The antenna array is coupled to at least one of the transmit paths. The method also includes measuring angle of arrival information from a signal originating from a mobile station at the first base transceiver station and storing a set of beamforming coefficients correlated from the angle of arrival information. The method further includes correlating the beamforming coefficients into a first beam pattern for the base transceiver station. The method also further includes receiving an access probe from the mobile station and increasing the initial power until a transmit power equals a predetermined level. Still further, the method includes computing a gain parameter based on the transmit power of the received access probe and modifying the beamforming coefficients by the gain parameter. Finally, the method includes creating a second beam pattern based on the modified beamforming coefficients for the base transceiver station.

The foregoing has outlined rather broadly the features and technical advantages of the subject matter disclosed so that those skilled in the art may better understand the detailed description that follows. Additional features and advantages will be described hereinafter that form the subject of the claims. Those skilled in the art will appreciate that they may readily use the conception and the specific embodiment(s) disclosed as a basis for modifying or designing other structures for carrying out the same purposes identified herein, as well as other purposes. Those skilled in the art will also realize that such equivalent constructions do not depart from the spirit and scope of the disclosed subject matter in its broadest form.

Before undertaking the DETAILED DESCRIPTION OF THE DISCLOSURE below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1, 1A and 1B are high-level block diagrams of a wireless network and portions thereof having a small office/home office base transceiver station according to an embodiment of the disclosure;

FIG. 2 is a high-level block diagram of an exemplary adaptive antenna array of a small office/home base transceiver station according to an embodiment of the disclosure;

FIG. 3 is an illustration of an exemplary access probe transmission sequence according to an embodiment of the present disclosure;

FIG. 4 is an illustration of an exemplary beam pattern formed by an adaptive antenna array according to an embodiment of the present disclosure; and

FIGS. 5A, 5B and 5C are high level flowcharts for a process of managing transmit power in a small office/home office base transceiver station according to an embodiment of the present disclosure.

### DETAILED DESCRIPTION OF THE DISCLOSURE

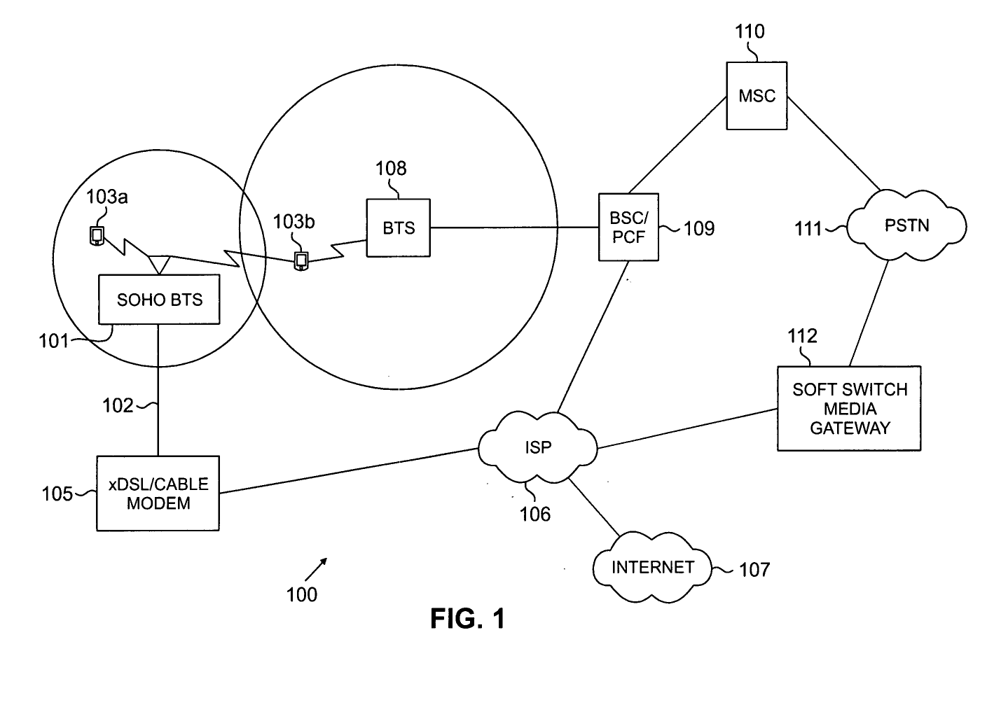

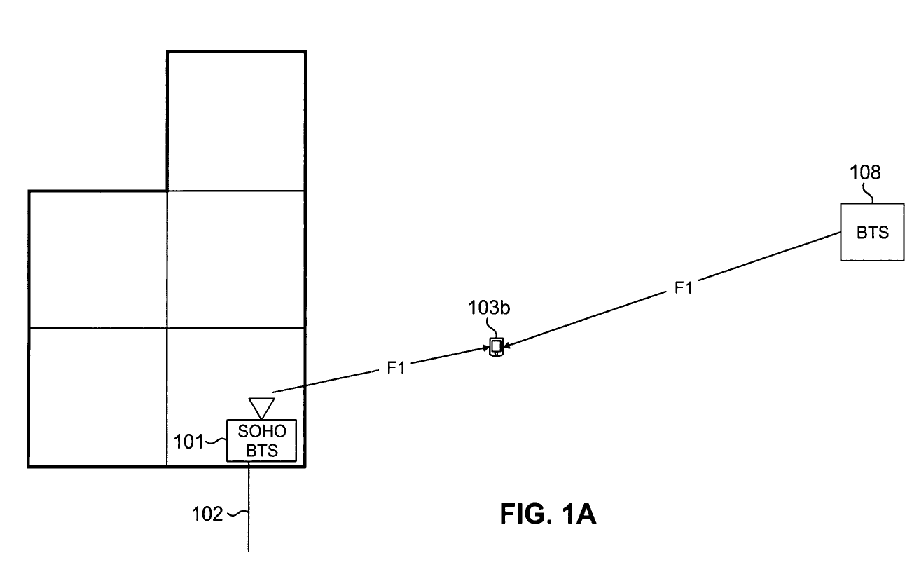

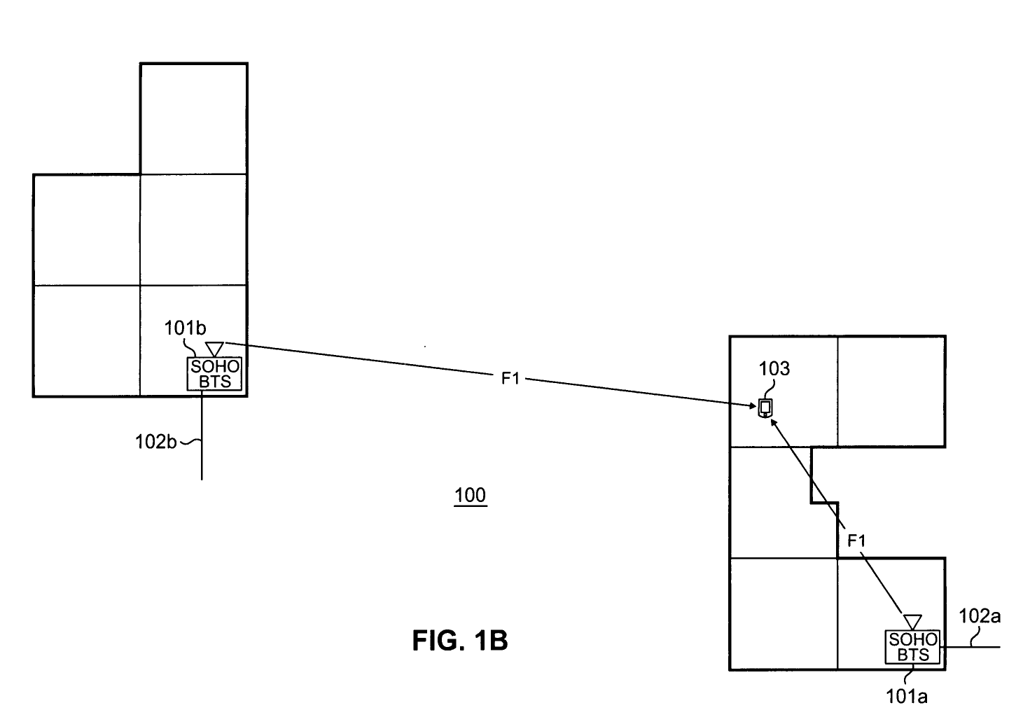

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device.

FIG. 1 is high-level diagram of a wireless network and portions thereof having a small office or home office base transceiver station according to one embodiment of the present disclosure. A wireless network 100 includes a small office or home office (SOHO) base transceiver station 101 (“SOHO BTS”). Mobile station 103a and mobile station 103b are capable of wirelessly connecting to SOHO BTS 101. SOHO BTS 101 comprises connection 102 to an asymmetric digital subscriber line (ADSL) or symmetric digital subscriber line (SDSL) (collectively xDSL) or cable modem 105. xDSL/cable modem 105 is connected to an Internet service provider (ISP) 106 which, in turn, is connected to the Internet 107. Mobile station 103a and mobile station 103b are also capable of connecting to a conventional wireless base station transceiver BTS 108 and others not shown.

BTS 108 is coupled to, for example, a base station controller (BSC) 109 with optional Packet Control Function (PCF). BSC/PCF 109 may be coupled to ISP 106. In addition, BSC/PCF 109 also may be coupled to mobile switching center (MSC) 110 which, in turn, is coupled to public-switched telephone network (PSTN) 111. Preferably, a soft switch media gateway 112 is coupled to ISP 106 and PSTN 111, respectively.

Those skilled in the art will recognize that the components depicted and described herein form a portion of and operate in conjunction with a larger wireless communications network having a number of macrocells (such as but not limited to the network 100 depicted in FIG. 1), with small BTS 101a and BTS 101b and subscriber unit or mobile device 103a located in one such macrocell. For simplicity and clarity, however, only so much of the construction and operation of the overall wireless communications network and the components therein as is unique to the present disclosure or necessary for an understanding of the present disclosure is depicted in FIGS. 1A and 1B and described in detail herein.

For in-building applications, SOHO BTS 101 is located within the confines of the small office or home office as shown in FIG. 1A. BTS 101 provides sufficient transmit power to overcome attenuation of the interior walls and floors. BTS 101 also provides sufficient transmit power to enable wireless communication with mobile device 103a when mobile device 103a does not receive sufficient power from BTS 108 for wireless communication with BTS 108. In other words, BTS 101 supplements a macrocell network where the coverage is poor due to propagation loss or obstructions, or where no wireless service is provided but xDSL or cable broadband services exists through wireline connections. However, where wireless communications through a macro BTS 108 is provided in the area including the small office or home office, BTS 101 should operate without introducing significant interference to the external coverage environment.

In a preferred embodiment, BTS 101 operates on the same wireless channel (F1) as BTS 108 as depicted in FIG. 1A. BTS 101 interferes with the signal reception from BTS 108 by MS 103b. Operation using the same carrier channel is necessary where, for example, spectrum is not available for dedicated small BTS operation. BTS 101 preferably transmits sufficient power to overcome interior wall (and ceiling/floor) penetration losses in order to provide sufficient signal strength to a mobile device within a distant room. However, since the outside wall or window attenuation may be less that the total interior wall penetration loss, a strong signal may be transmitted through the outside wall to interfere with the external coverage provided by the macrocell network through BTS 108. This interference could be so severe as to cause a mobile device 103 call failure, loss of pilot and experience handoff failure.

FIG. 1B illustrates SOHO BTS 101a (in one home) interfering with the operation of SOHO BTS 101b (in an adjacent home). This interference scenario is sometimes referred to as the “hidden node problem.” Due to the differences between outside wall penetration loss and total interior wall penetration loss, interference with an adjacent SOHO BTS cell can occur. Often times, the wall penetration loss and propagation loss between BTS 101a and BTS 101b, for example, are too great for each to discover the other. In the scenario shown in FIG. 1B, SOHO BTS 101a and SOHO BTS 101b are located within the confines of an office building or home to supplement a macrocell network where either coverage is poor or there is no wireless service but broadband wireline service exists. SOHO BTS 101a and SOHO BTS 101b provide sufficient transmit power to overcome the attenuation of interior walls and floors in the building (depicted by the thinner lines), and inadvertently, also to overcome the attenuation of exterior walls (depicted by the thicker lines). SOHO BTS 101a and SOHO BTS 101b are located proximate to a broadband wireline (e.g., T1, cable or digital subscriber line) access point for the respective buildings. Each SOHO BTS 101a and SOHO BTS 101b has a connection 102a and connection 102b, respectively, to a broadband wireline communications system (not shown).

A fixed or mobile “subscriber” device 103 is preferably capable of wireless communication with both BTS 101a and BTS 101b as depicted in FIG. 1A. Mobile device 103 may be any device having such communication capability such as a telephone, wireless electronic mail and/or Short Message Service (SMS) text messaging device, and/or a personal digital assistant (PDA), or a desktop or laptop computer, etc. BTS 101a, BTS 101b and mobile device 103 are capable of communicating with each other using any one or more of the IEEE 802.11, IEEE 802.16, IS-95 Code Division Multiple Access (CDMA) (also referred to as TIA-EIA-95 or “cdmaOne”), CDMA 2000, CDMA 1X, and/or CDMA 1X EV-DO standards.

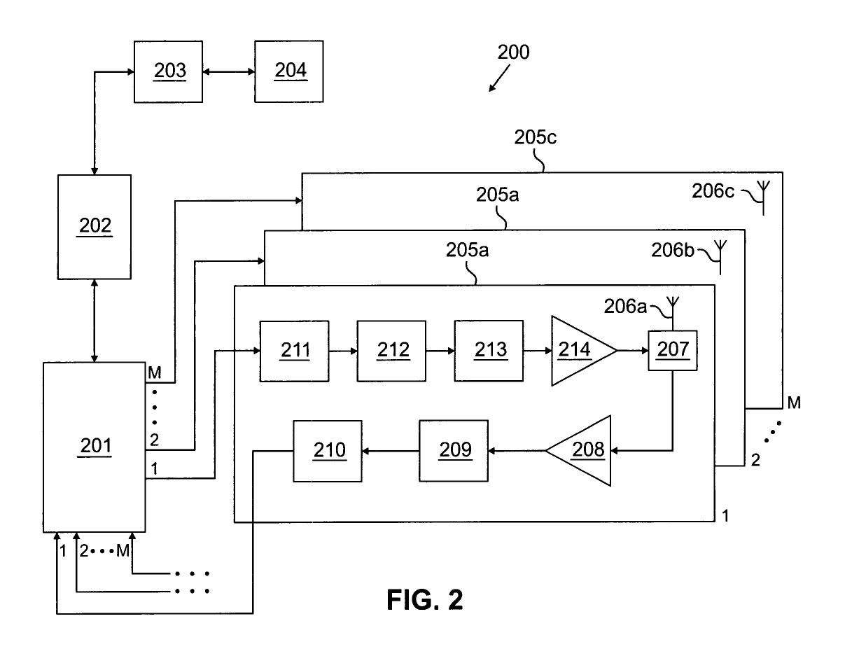

FIG. 2 is a high-level block diagram of a small office/home office base transceiver station (e.g., SOHO BTS 101b) with an exemplary adaptive antenna array BTS system 200 according to an embodiment of the present disclosure. System 200 discovers the angle of arrival for mobile station signals by performing different acoustical array techniques as later described in detail herein. System 200 places radio frequency (RF) power in the SOHO where it is required while minimizing interference with other mobile stations. System 200 preferably operates in a CDMA air interface and is in communication with BTS 101b. BTS 101b includes a processor or controller 201, CDMA modem 202, Resource Manager 203 and Call Manager 204. BTS 101b maybe in communication with multiple transceivers 205a, 205b and 205c (referred to collectively herein as transceiver 205). Each transceiver 205a, 205b and 205c includes an antenna, for example antennas 206a, 206b and 206c, respectively. Antennas 206a, 206b and 206c are collectively referred to herein as antenna 206.

Transceiver 205 is in communication with one or more mobile stations (e.g., MS 103a). In conjunction with the following description, it is generally assumed that there are an M number of transceivers 205 in system 200. For example, although only three transceivers 205 are shown, it should be understood that any number of transceivers 205 may be used in accordance with the present disclosure. Transceiver 205a preferably includes antenna 206a, duplexer (DUP) 207, low noise amplifier (LNA) 208, down-converter and filter 209 and I/Q demodulator 210, as depicted in FIG. 2. In accordance with an embodiment of the present disclosure, the uplink and downlink processes described below are generally the same for each sector (α, β, γ)

During an uplink, signals from MS 103a via antenna 206a are isolated by duplexer (DUP) 207 and then processed by transceiver 205a in accordance with an embodiment of the present disclosure. Specifically, a signal uplinked from MS 103a is received by antenna 206a and amplified by LNA 208. The signal is then down-converted and filtered in filter 209. Because the received signal is a modulated digital signal made of two independent components, the “I” or in-phase component and the “Q” or quadrature component, the signal is then demodulated into its respective I and Q digital streams by I/Q demodulator 210. The I and Q digital streams are fed to adaptive antenna array processor 201 for each channel element (CE). Antenna array processor 201 performs despreading and M-ary symbol detection prior to being processed by CDMA modem 202. CDMA modem 202 is capable of supporting signal processing for N users. During an uplink, adaptive antenna array processor 201 estimates uplink and downlink beamforming (BF) weight vector coefficients. Adaptive antenna array processor 201 also estimates the time of arrival over several symbol periods of the received signal for each mobile station (e.g., MS 103a). Adaptive antenna array processor 201 passes the beamforming coefficient information to Resource Manager 203. Resource Manager 203 stores the beamforming coefficient information preferably in table format. Any reception of an access signal by the uplink on a receiver and detection circuit path in transceiver 205 are also identified to Resource Manager 203.

Resource Manager 203 receives the signals from Call Manager 204 and performs several different tasks. Specifically, Resource Manager 203 assigns a channel element, Walsh code and sector (if used) for each traffic channel established between the BTS 101 and a mobile station 103a. Resource Manager 203 also maintains a database in memory for, for example, the beamforming coefficients, time of arrival of uplink signals, idle/active state of each Walsh code, and the assignment of that Walsh code to active channel. Using information maintained in memory, Resource Manager 203 also computes the average motion of MS 103b from the rotation rate of the beamforming weight vectors measured over multiple symbol intervals.

During downlink to MS 103a, a similar process occurs. For example, the incoming I and Q data streams to the channel element are processed in CDMA modem 202. CDMA modem 202 provides Walsh code modulation and pseudo-noise (PN) code spreading on the downlink. Then, the output of CDMA modem 202 is multiplied by M×1 downlink beamforming weight vector of MS 103a in the adaptive antenna array processor 201. The output will eventually be distributed to M antenna elements or antenna array 206 for transmission in a given sector. Hence, in accordance with an embodiment of the present disclosure, the beamforming process simply performs amplitude weighting and phase shifting of each mobile station's I and Q digital data and also converts the data to M×1 vector form. I-Q combiner 211 combines I digital stream from N channel elements from CDMA modem 202. Similarly, I-Q combiner 211 combines Q digital stream from N channel elements from CDMA modem 202. The combined I and Q signals from I-Q combiner 211 are applied to an I-Q modulator 212 which modulates a carrier frequency. The modulated signal is then up converted and filtered in filter 213. The signal is passed through amplifier 214 and fed to each antenna element via a duplexer (DUP) 207. Finally, the signals at antenna array 205 are transmitted to MS 103a.

Once SOHO BTS 101 has powered up, SOHO BTS 101 operates in one of four main modes in accordance with the present disclosure. For example, if BTS 101 is in a first mode or “user configuration” mode, BTS 101 initially configures system 200 for uniform coverage. In other words, BTS 101 configures antenna 206 for uniform coverage of the SOHO interior. BTS 101 then performs several signal strength measurements to “discover” or “learn” the beamforming coefficients in accordance with an embodiment of the present disclosure. For example, in the “user configuration” mode, the user sets up a “test call” and may move through the interior of the SOHO. During the “test call”, BTS 101 learns the angle of arrival of a signal from MS 103a signal with smart antenna beamforming techniques. Resource Manager 203 stores the received set of beamforming coefficients in memory and preferably maintains the information in table form. Resource Manager 203 then uses the stored beamforming array to establish a beam pattern for SOHO interior coverage for the overhead and traffic channels. For example, as mentioned before, BTS 101 initially configures system 200 for uniform coverage. After the user places the test call, however, BTS 101 learns the angle of arrival of the mobile station or access terminal (e.g., MS 103a) with smart antenna beamforming techniques to create an initial beam pattern for the SOHO.

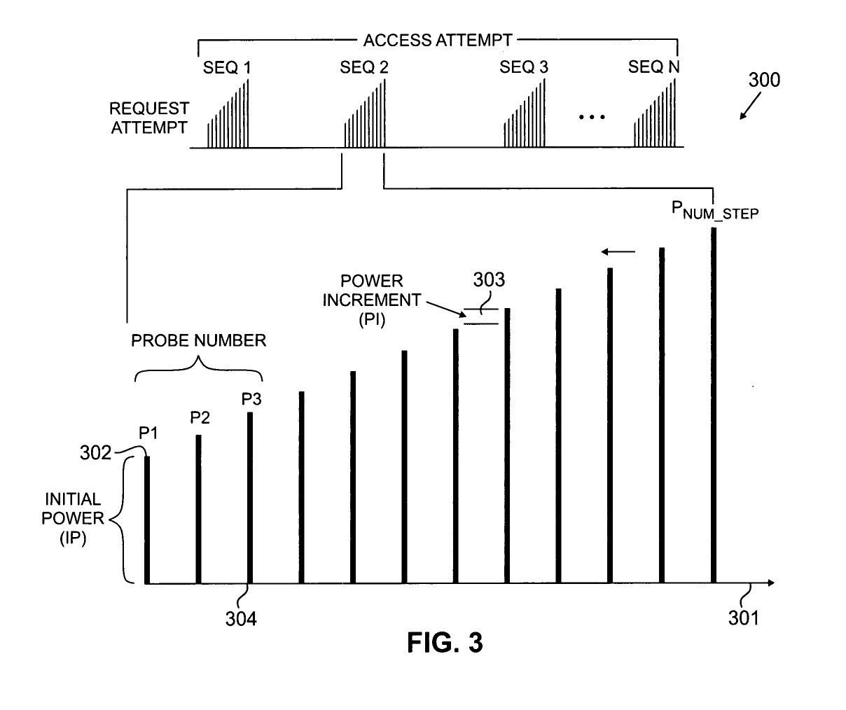

After completion of the “user configuration” mode, system 200 may continue operation in a second mode. The “user configuration” mode seeks to adapt the beam pattern according to the current or learned SOHO conditions. For example, after MS 103a receives a call BTS 101 begins to learn the attenuation between BTS 101 and MS 103a from access probe sequence numbers. FIG. 3 illustrates the access probe transmission sequence 300 according to an embodiment of the present disclosure. MS 103a starts the transmission of the access probes 301 with an initial power (IP) setting 302. MS 103a then continuously increases the power for the access probe 301 by an incremental step 303. The incremental step (or Power Increment (PI)) 303 continues until all probes 301 are sent as set by a NUM_STEP parameter. It is not necessary for BTS 101 to send an acknowledgment message to MS 103a even though it has successfully received the access probe 301. Instead, BTS 101 computes the difference between the NUM_STEP parameter and the number of received access probes 301 to determine the attenuation factor between the BTS 101 and MS 103a.

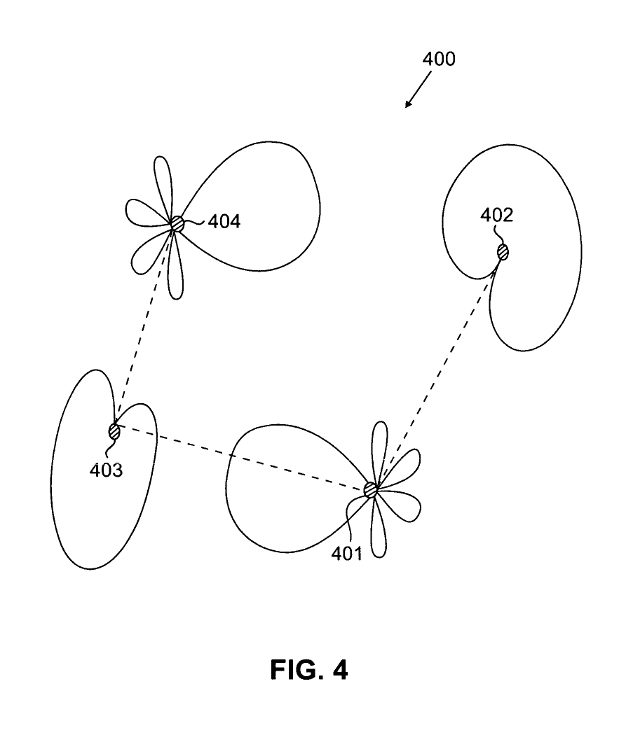

The number of missing access probes 301 multiplied by PI 303 indicates the added attenuation between BTS 101 and MS 103a. BTS 101 then converts the attenuation parameter into a gain parameter that modifies the beamforming coefficients. For example, suppose NUM_STEP were to equal the power associated with access probe P3 (e.g. access probe 304). Accordingly, MS 103a would continue transmission until access probe 304 was sent. BTS 101 would then compute the difference between the attenuation factor between BTS 101 and MS 103a. Resource Manager 203 stores the set of beamforming coefficients for the angle of arrival and the gain parameter corresponding to the angle of arrival in memory. Resource Manager 203 uses the beamforming array coefficients adjusted by the gain parameter to establish a beam pattern (such as beam pattern 400 shown in FIG. 4) for SOHO interior coverage, and in particular, for the overhead and traffic channels associated with BTS 101, in accordance with an embodiment of the present disclosure.

In a third or “update” mode, BTS 101 uses the procedure performed in the “user configuration” mode and then updates the beam coefficient array with the method performed in the “access” mode. Thus, as new calls are placed, the beam pattern for the SOHO interior can be reassessed and adjusted if need be in accordance with an embodiment of the present disclosure. As more calls are placed and received, system 200 continues to update the beam coefficient array and optimizes system 200.

In a fourth or “interference optimization” mode, BTS 101 scans the environment for other mobile station signals which will interfere with the operation of BTS 101. Similarly, BTS 101 scans the environment for signals in which BTS 101 will interfere with any other mobile stations. In order to do both interference cancellation and interference avoidance, BTS 101 learns or discovers the angle of arrival of signals from such mobile stations (θᵢ). BTS 101 will also need to find the received signal strength (I_{Rx, i}). Once BTS 101 secures these two parameters, BTS 101 will preferably never transmit more than the difference between the maximum transmit power level and the received signal strength (β-I_{Rx, i}) in the θᵢ direction, where β is the maximum transmit power level. Accordingly, the interference to the desired mobile stations will be limited. BTS 101 will null out the interference coming from direction θᵢ when receiving signals as seen in FIG. 4. Accordingly, an embodiment of the present disclosure uses beamforming techniques to place the transmitted power where it is needed within the SOHO. The antenna array 206 forms beams toward the intended recipient and forms nulls towards the interferer. For example, still referring to FIG. 4, suppose that in system 400, a base transceiver station (e.g., BTS 401) is subject to an interfering signal originating from a mobile station (e.g., MS 402). At the same time, suppose transmitted power from BTS 401 is required to another mobile station (e.g., MS 403). BTS 401 would place MS 402 in a null by using interference cancellation techniques, while using the beamforming techniques to place transmitted power to MS 403 in accordance with an embodiment of the present disclosure.

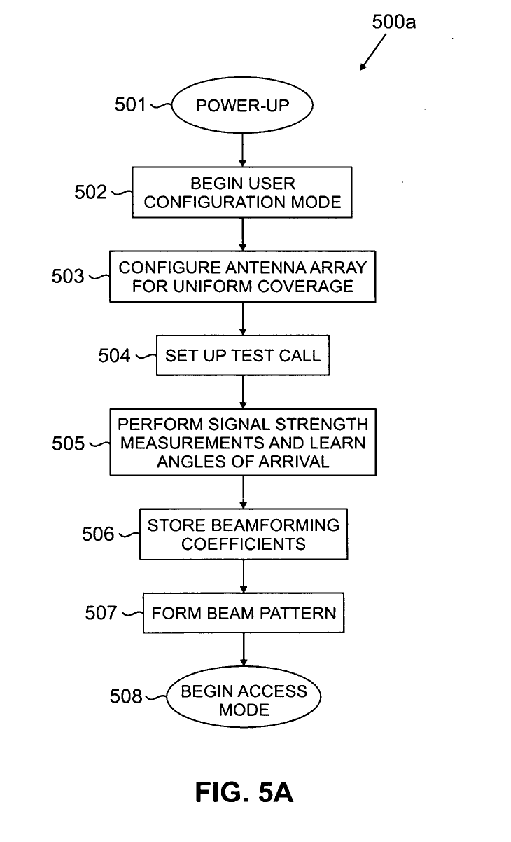

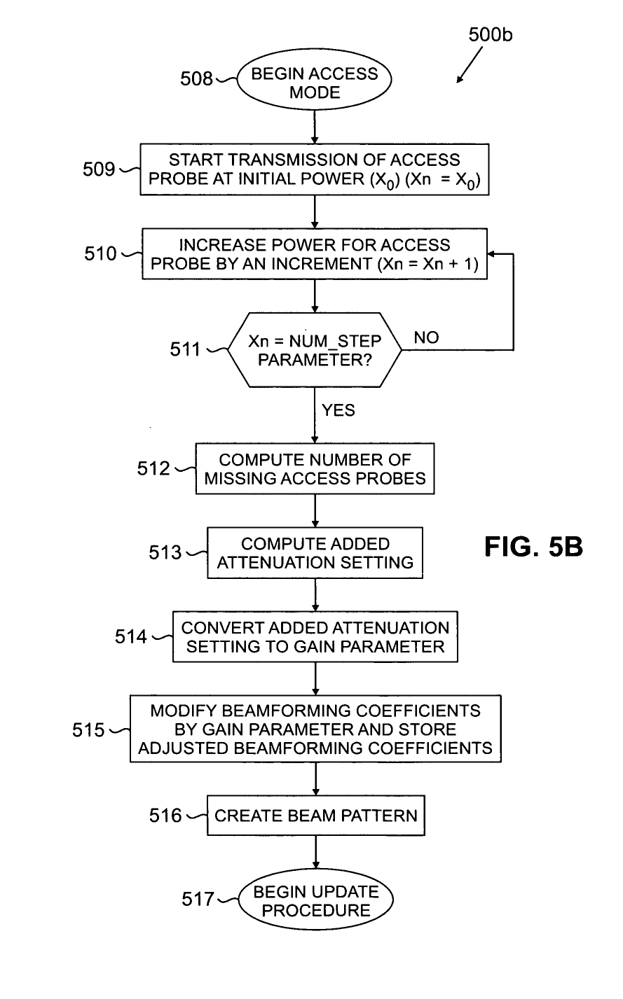

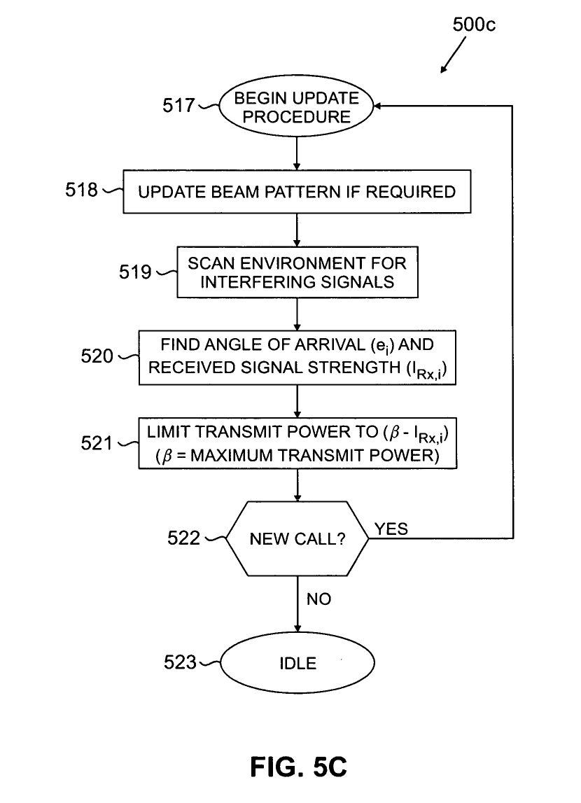

FIGS. 5A, 5B and 5C are high level flowcharts for process 500a, 500b and 500c, respectively. Processes 500a, 500b and 500c are sometimes collectively referred to as process 500 herein. Process 500 generally manages interference from SOHO BTS units by discovering the angle of arrival for mobile station signals according to an embodiment of the present disclosure. Referring first to FIG. 5A, process 500a begins with a SOHO BTS (e.g., BTS 101) powered up in step 501, BTS 101 begins operation in a first mode or “user configuration” mode in step 502 to initially configure antenna array (e.g., antenna array 206) for uniform coverage in step 503. Then in step 504, the user may set up a “test call” and move about the interior of the small office or home to capture angle of arrival information. BTS 101 performs several signal strength measurements to “discover” or “learn” the beamforming coefficients in accordance with an embodiment of the present disclosure in step 505. During the call, BTS 101 also learns the angle of arrival of an MS 103a signal with smart antenna beamforming techniques. Resource Manager 203 stores the received set of beamforming coefficients in memory, preferably in table form in step 506. In step 507, Resource Manager 203 uses the beamforming array to establish a beam pattern for small office or home interior coverage for the overhead and traffic channels.

After completion of the “user configuration” mode, process 500a may continue in a second mode in process 500b. In step 508, the second or “access” mode begins and BTS 101 learns the attenuation between BTS 101 and MS 103a from access probe sequence numbers. MS 103a starts the transmission of the access probes with an initial power (IP) setting (X₀) in step 509. MS 103a continuously increases the power (Xₙ) for the access probe by an incremental step in step 510. The incremental step (or Power Increment (PI)) continues until all probes are sent as set by a NUM_STEP parameter in step 511. In step 512, BTS 101 computes the difference between the NUM_STEP parameter and the number of received probes to determine the attenuation factor between BTS 101 and MS 103a. The number of missing access probes multiplied by the PI indicates the added attenuation between BTS 101 and MS 103a in step 513. BTS 101 converts this attenuation parameter into a gain parameter and modifies the beamforming coefficients accordingly in step 514. Resource Manager 203 stores the set of beamforming coefficients for the angle of arrival and the gain parameter corresponding to the angle of arrival in memory in step 515. In step 516, Resource Manager 203 uses the beamforming array coefficients adjusted by the gain parameter to establish a beam pattern for small office or home interior coverage for the overhead and traffic channels in accordance with an embodiment of the present disclosure.

In process 500c, when a user receives or places another call, BTS 101 begins an update procedure in step 517 to update the beam coefficient array and parameters found in process 500b. Thus, as new calls are placed, the beam pattern for the small office or home interior can be reassessed in process 500c and adjusted in step 518 if need be, in accordance with an embodiment of the present disclosure. In step 519, BTS 101 performs “interference optimization” and scans the environment for other SOHO base station transceiver signals which will interfere with the operation of BTS 101. Similarly, BTS 101 scans the environment for signals in which BTS 101 will interfere with any other SOHO base station transceiver. In order to do both interference cancellation, as well as interference avoidance, BTS 101 needs to find the angle of arrival of the other base transceiver stations (θᵢ) and the received signal strength (I_{Rx, i}) in step 520. Once BTS 101 secures these two parameters, BTS 101 will preferably never transmit more than β-I_{Rx, i} dB power in the θᵢ direction in step 521, where β is the maximum transmit power level. Accordingly, the interference to the other base station transceivers will be limited.

BTS 101 will null out the interference coming from direction θᵢ when it is receiving signals and place the transmitted power where it is needed within the small office or home. The adaptive array transmitter forms beams toward the intended recipient and forms a null towards the interferer. As new calls arrive or are placed in step 522, process 500c repeats, else process 500c remains in idle in step 523. According to an embodiment of the present disclosure, process 500 thus uses beamforming techniques and angle of arrival information to place transmitted power where it is needed in a small office or home.

Beamforming techniques in accordance with an embodiment of the present disclosure limit the radiated power where there is the potential for interference with macro-cellular coverage or with adjacent mobile station coverage. Preferably, embodiments of the present disclosure combine smart antenna beamforming with access probe information to determine the direction for radiated power and the level of the needed transmitted power as well for the SOHO environment. Embodiments of the present disclosure also provide an efficient system for placement of RF power in the SOHO where it is needed and minimizes radiating power in directions where it will cause interference with macrocell coverage. In addition, the present disclosure provides a small base transceiver station (BTS) with an economical method to quickly solve coverage issues internal to a small office or home (SOHO) without introducing interference external to this coverage environment. It supplements a macrocell network where the coverage is poor or there is no wireless service and broadband service exists.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A system for managing interference with a base transceiver station having one or more transmit paths, the system comprising:
an antenna array coupled to at least one of the transmit paths; and
a controller to direct a setting for the antenna array of the base transceiver station based on an angle of arrival of a signal from a mobile station.

2. The system according to claim 1, wherein the angle of arrival correlates to a beam forming coefficient.

3. The system according to claim 2, wherein the beam forming coefficient correlates to a beam pattern.

4. The system according to claim 2, further comprising a memory to store the beam forming coefficients in table form.

5. The system according to claim 2, further comprising a processor to estimate uplink beamforming coefficients.

6. The system according to claim 2, further comprising a processor to estimate downlink beamforming coefficients.

7. The system according to claim 1, further comprising a processor to compute an average motion of the mobile station from the beam forming coefficient.

8. The system according to claim 7, wherein the average motion is correlated over time.

9. A method for managing interference from a base transceiver stations having one or more transmit paths, the method comprising:
directing an antenna array coupled to at least one of the transmit paths of the base transceiver station based on an angle of arrival of a signal from a mobile station.

10. The method according to claim 8, further comprising correlating a beam forming coefficient from the angle of arrival.

11. The method according to claim 9, further comprising correlating the beam forming coefficient into a beam pattern.

12. The method according to claim 9, further comprising storing the beamforming coefficients in memory in table form.

13. The method according to claim 9, further comprising estimating an uplink beamforming coefficient.

14. The method according to claim 9, further comprising estimating a downlink beamforming coefficient.

15. The method according to claim 8, further comprising computing an average motion of the mobile station from the beam forming coefficient.

16. The method according to claim 14, wherein the computing the average motion is accomplished over time.

17. A method for managing interference from a base transceiver station having one or more transmit paths, comprising:
configuring an antenna array at the base transceiver station for uniform coverage, the antenna array coupled to at least one of the transmit paths;
measuring angle of arrival information from a signal originating from a mobile station at the first base transceiver station;
storing a set of beamforming coefficients correlated from the angle of arrival information;
correlating the beamforming coefficients into a first beam pattern for the base transceiver station;
receiving an access probe from the mobile station;
increasing the initial power until a transmit power equals a predetermined level;
computing a gain parameter based on the transmit power of the received access probe;
modifying the beamforming coefficients by the gain parameter; and
creating a second beam pattern based on the modified beamforming coefficients for the base transceiver station.

18. The method according to claim 17, wherein the received access probe transmit power correlates to a NUM_STEP parameter.

19. The method according to claim 18, wherein the gain parameter is determined a relationship between the NUM_STEP parameter, the received access probes from the mobile station, and the initial power setting.

20. The method according to claim 17, further comprising determining a new beam pattern when a new call is placed.
